(19) United States
(12) Patent Application Publication
(10) Pub. No.: US 2021/0016242 A1
(43) Pub. Date: Jan. 21, 2021

(54) FLOW TYPE REACTION DEVICE

(71) Applicant: TAIYO NIPPON SANSO CORPORATION, Tokyo (JP)

(72) Inventors: Kazuya SAKAI, Tokyo (JP); Shinya TOKUOKA, Tokyo (JP)

(21) Appl. No.: 16/766,879

(22) PCT Filed: Nov. 9, 2018
(86) PCT No.: PCT/JP2018/041661

§ 371 Date: May 26, 2020

(30) Foreign Application Priority Data
Dec. 5, 2017 (JP) 2017-233618

(51) Int. Cl. B01J 19/24; B01J 10/00; C01B 35/02; B01F 3/04; B01F 5/04

(52) U.S. Cl. CPC B01J 19/24; B01J 10/00; C01B 35/02; B01F 2215/0036; B01F 5/0486; B01J 2219/00033; B01F 3/0446

(57) ABSTRACT

An object of the present invention is to provide a flow type reaction device which is capable of maintaining reaction efficiency and productivity which are sufficient for practical use for a long time, and reducing the size and cost of the reaction device, and the present invention provides a flow type reaction device (1) for continuously reacting two or more kinds of raw materials, including a mixing section (10) which is configured to mix two or more kinds of the raw materials, and a reaction section (20) which is provided on a secondary side with respect to the mixing section (10), and configured to obtain a product by reacting two or more kinds of the raw materials, the mixing section (10) includes a mixing device (13) which is configured to mix two or more kinds of the raw materials, and two or more supply pipes (L11, L12) which are configured to supply each of two or more kinds of the raw materials to the mixing device (13), the supply pipes (L11, L12) are respectively connected to the mixing device (13), and at least one of the supply pipes (L11) has, in the vicinity of a connection portion of the supply pipe (L11) with the mixing device (13), a suppression mechanism which is configured to suppress movement of a fluid from the mixing device (13) to the supply pipe (L11).

### FIELD OF THE INVENTION

The present invention relates to a flow type reaction device. Priority is claimed on Japanese Patent Application No. 2017-233618, filed on Dec. 5, 2017, the content of which is incorporated herein by reference.

### DESCRIPTION OF RELATED ART

A flow type reaction device that continuously supplies raw materials to a reaction field and continuously performs a chemical reaction has attracted attention. Compared with a so-called batch type reaction device, a flow type reaction device has advantages such as ability to produce a target substance with higher production efficiency, ability to artificially control a chemical reaction, and a smaller and safer reaction facility.

However, the flow type reaction device has a problem that a supply pipe for supplying a raw material to a reaction field is easily blocked by a solid or the like generated as a by-product of a chemical reaction. Therefore, Patent Documents 1 to 3 disclose techniques for coping with the blockage.

### PRIOR ART DOCUMENTS

### Patent Documents

Patent Document 1: Japanese Unexamined Patent Application, First Publication No. 2012-228666
Patent Document 2: Japanese Unexamined Patent Application, First Publication No. 2004-344877
Patent Document 3: Japanese Unexamined Patent Application, First Publication No. 2006-181525

### DISCLOSURE OF THE INVENTION

### Problem to be Solved by the Invention

However, in the devices disclosed in Patent Document 1 to 3, when a sudden change in pressure or the like occurs in a reaction field due to the progress of a chemical reaction, a backflow of liquid frequently occurs in the devices. Due to the backflow, there is a problem that the liquid adheres to the supply pipe and solids are deposited, thereby blocking the supply pipe.

Therefore, in the devices disclosed in Patent Documents 1 to 3, when the device is operated for a long time, blockage of the supply pipe or the like occurs due to the backflow, and the raw materials cannot be supplied into the reaction field.

Therefore, in the devices disclosed in Patent Documents 1 to 3, the reaction efficiency decreases with the progress of the chemical reaction, and the operation time and high productivity which are sufficient for practical use cannot be secured. In addition, due to the reduction in reaction efficiency, unreacted raw materials are mixed into the final product, and the quality such as the purity of the target substance is reduced.

Further, the device disclosed in Patent Document 1 has an essential configuration such as an ultrasonic vibrator for applying ultrasonic vibration to the supply pipe, and is not suitable for reducing the size and cost of the reaction equipment.

The present invention has been made in view of the above circumstances, and an object of the present invention is to provide a flow type reaction device which is capable of maintaining reaction efficiency and productivity which are sufficient for practical use for a long time, and reducing the size and cost of the reaction device.

### Means to Solve the Problem

In order to solve the problems, the present invention provides the following flow type reaction devices.

(1) A flow type reaction device for continuously reacting two or more kinds of raw materials,

wherein the flow type reaction device includes a mixing section which is configured to mix two or more kinds of the raw materials, and a reaction section which is provided on a secondary side with respect to the mixing section, and configured to obtain a product by reacting two or more kinds of the raw materials,

the mixing section includes a mixing device which is configured to mix two or more kinds of the raw materials, and two or more supply pipes which are configured to supply each of two or more kinds of the raw materials to the mixing device,

the supply pipes are respectively connected to the mixing device, and at least one of the supply pipes has, in the vicinity of a connection portion of the supply pipe with the mixing device, a suppression mechanism which is configured to suppress movement of a fluid from the mixing device to the supply pipe.

[2] A flow type reaction device for continuously reacting two or more kinds of raw materials,

wherein the flow type reaction device includes a mixing section which is configured to mix two or more kinds of the raw materials, and a reaction section which is provided on a secondary side with respect to the mixing section, and configured to obtain a product by reacting two or more kinds of the raw materials,

the mixing section includes a mixing device which is configured to mix two or more kinds of the raw materials, and two or more supply pipes which are configured to supply each of two or more kinds of the raw materials to the mixing device,

the supply pipes are respectively connected to the mixing device, and at least one of the supply pipes is connected to the mixing device from above with respect to a plane on which the mixing device is disposed.

[3] A flow type reaction device for continuously reacting two or more kinds of raw materials,

wherein the flow type reaction device includes a mixing section which is configured to mix two or more kinds of the raw materials, and a reaction section which is provided on a secondary side with respect to the mixing section, and configured to obtain a product by reacting two or more kinds of the raw materials,

the mixing section includes a mixing device which is configured to mix two or more kinds of the raw materials, and two or more supply pipes which are configured to supply each of two or more kinds of the raw materials to the mixing device,

the supply pipes are respectively connected to the mixing device, and at least one of the supply pipes has, in the vicinity of a connection portion of the supply pipe with the mixing device, a suppression mechanism which is configured to suppress movement of a fluid from the mixing device to the supply pipe, and

at least one of the supply pipes is connected to the mixing device from above with respect to a plane on which the mixing device is disposed.

[4] The flow type reaction device according any one of [1] to [3],

wherein two or more kinds of the raw materials are a combination of one or more kinds of gaseous raw materials and one or more kinds of liquid raw materials.

[5] The flow type reaction device according [2] or [3],

wherein two or more kinds of the raw materials are a combination of one or more kinds of gaseous raw materials and one or more kinds of liquid raw materials,

at least one of the supply pipes which is configured to supply the gaseous material to the mixing device is connected to the mixing device from above with respect to a plane on which the mixing device is disposed, and

at least one of the supply pipes which is configured to supplying the liquid raw material to the mixing device is connected to the mixing device in parallel to a plane on which the mixing device is disposed.

[6] The flow type reaction device according any one of [1] to [5],

wherein the flow type reaction device further includes a separation section which is provided on a secondary side with respect to the reaction section, and configured to separate a target substance from a product.

### Effects of the Invention

According to the flow type reaction device of the present invention, the reaction efficiency and the productivity which are sufficient for practical use can be maintained for a long time, and the reaction apparatus including the flow type reaction device can be reduced in size and cost.

### BRIEF DESCRIPTION OF DRAWINGS

FIG. 1 is a system diagram schematically showing an example of a configuration of a flow type reaction device of a first embodiment according to the present invention.

FIG. 2 is a cross-sectional view in an x-y plane direction showing a mixing device provided in the flow type reaction device according to the first embodiment.

FIG. 3 is a system diagram schematically showing an example of a configuration of a flow type reaction device of a second or third embodiment according to the present invention.

FIG. 4 is a cross-sectional view in an x-z plane direction showing a mixing device provided in the flow type reaction device according to the second embodiment.

FIG. 5 is a cross-sectional view in an x-z plane direction showing a mixing device provided in the flow type reaction device according to the third embodiment.

FIG. 6 is a diagram showing a change over time in a supply amount of a gaseous raw material in Example 1.

FIG. 7 is a diagram showing a change over time in a supply amount of a gaseous raw material in Example 2.

FIG. 8 is a diagram showing a change over time in a supply amount of a gaseous raw material in Example 3.

FIG. 9 is a diagram showing a change over time of a supply amount of a gaseous raw material in Comparative Example 1.

### DETAILED DESCRIPTION OF THE INVENTION

Hereinafter, a flow type reaction device of an embodiment according to the present invention will be described in detail with reference to the drawings. Moreover, in the drawings used in the following description, in order to make the characteristics easy to understand, the characteristic portions may be enlarged for convenience, and the dimensional ratios and the like of the respective components are not necessarily the same as the actual ones.

### First Embodiment

First, the configuration of the flow type reaction device 1 according to the first embodiment which is one embodiment according to the present invention will be described.

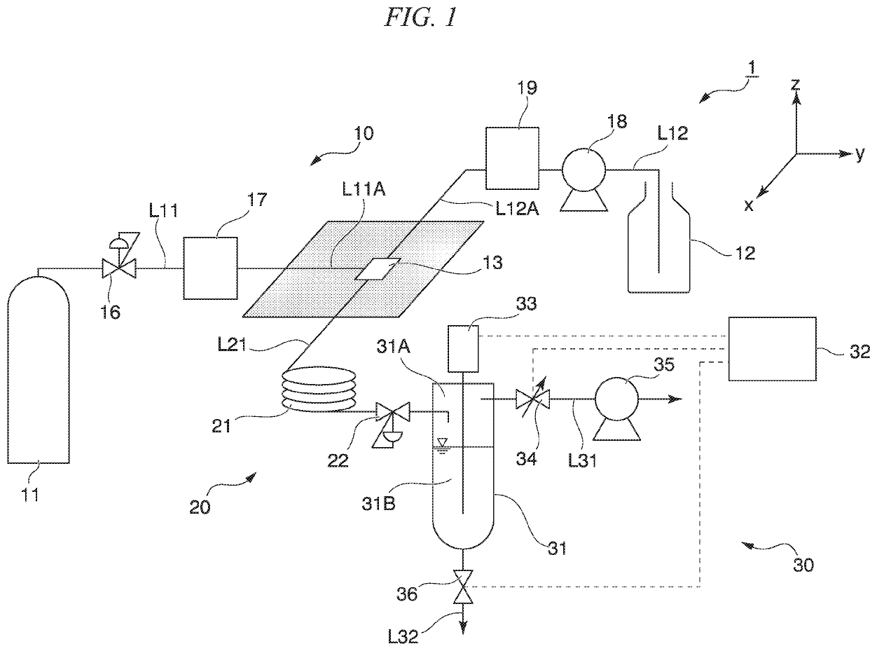

FIG. 1 is a system diagram schematically showing an example of a configuration of the flow type reaction device 1. In FIG. 1, the vertical direction is a z-axis direction. As shown in FIG. 1, a flow type reaction device 1 includes a mixing section 10 in which two or more kinds of raw materials are mixed, a reaction section 20 in which the raw materials mixed in the mixing section 10 are reacted, and a separation unit 30 in which a target substance is separated from the product generated in the reaction section 20.

Hereinafter, each component of the flow type reaction device 1 will be described in detail.

The configuration of the mixing section 10 is not particularly limited as long as two or more kinds of raw materials can be mixed and a mixture containing the raw materials can be supplied into the reaction section 20. Two or more kinds of the raw materials may be a combination of one or more kinds of gaseous raw materials and one or more kinds of liquid raw materials, a combination of two or more kinds of gaseous raw materials, or two or more kinds of liquid raw materials.

Hereinafter, the configuration of the mixing section 10 will be explained by taking as an example a case in which two or more kinds of the raw materials are a combination of one or more kinds of gaseous raw materials and one or more kinds of liquid raw materials, and the target substance is diborane gas.

The mixing section 10 includes a supply source 11 for one or more kinds of gaseous raw materials (boron trihalide gas such as BF₃ and BCl₃), a supply source 12 for one or more kinds of liquid raw materials (ether-based solvent such as ethylene glycol dimethyl ether, diethylene glycol dimethyl ether, and triethylene glycol dimethyl ether, which containing a reducing agent such as NaH and NaBH₄), a supply path L11 for the gaseous raw material, a supply path L12 for the liquid raw material, and a mixing device 13 which is connected to the two supply paths L11 and L12.

The supply path L11 is provided with a pressure regulating valve 16 and a mass flow controller 17 from the primary side (upstream side). The supply path L12 is provided with a liquid feed pump 18 and a mass flow controller 19 from the primary side (upstream side).

The supply path L11 is a path for supplying the gaseous raw material into the mixing device 13. The supply path L12 is a path for supplying the liquid material into the mixing device 13.

The material of pipes constituting the supply paths L11 and L12 is not particularly limited as long as it does not corrode by the gaseous raw material or the liquid raw material, and can be appropriately selected according to the properties of each raw material. Examples of the material of the pipe include a resin such as PTFE (polytetrafluoroethylene), and a metal such as SUS.

The diameter of the pipes constituting the supply paths L11 and L12 is not particularly limited, and can be appropriately selected according to the supply amounts of the respective raw materials into the mixing device 13. For example, a pipe having an outer diameter of 6 to 7 (mm) and an inner diameter of 4 to 5 (mm) can be used as the pipe constituting the supply paths L11 and L12.

The mixing device 13 is disposed horizontally on the x-y plane shown in FIG. 1. The mixing device 13 is not particularly limited as long as it can mix the raw materials (combinations of the gaseous raw material and the liquid raw material) supplied via the two supply paths L11 and L12. As the mixing device 13, a mixer and the like are exemplary examples.

The mixing device 13 is connected to a supply path L21 provided in the reaction section 20. Thereby, the mixing section 10 can supply the mixture of each raw material into the reaction section 20.

In the first embodiment, a primary portion L11A of the supply path L11 with respect to the mixing device 13, which is the connection portion of the supply path L11 with the mixing device 13, is horizontally disposed on the x-y plane shown in FIG. 1. Similarly, a primary portion L12A of the supply path L12 with respect to the mixing device 13, which is the connection portion of the supply path L12 with the mixing device 13, is horizontally disposed on the x-y plane shown in FIG. 1. That is, in the first embodiment, the primary portions L11A and L12A of the supply paths L11 and L12 with the mixing device 13, which are the connection portions of the supply paths 11 and 12 with the mixing device 13, are horizontally disposed on the same plane as the mixing device 13.

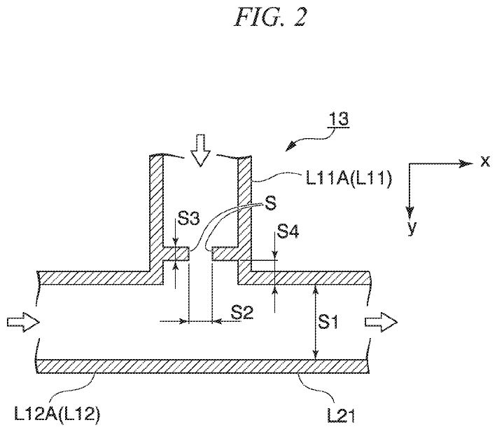

FIG. 2 is a cross-sectional view in the x-y plane direction showing the mixing device 13 provided in the flow type reaction device 1.

The white arrows shown in FIG. 2 indicate the directions of the raw materials flowing through the supply paths L11 and L12 and the mixture of the raw materials flowing through the supply path L21.

As shown in FIG. 2, in the first embodiment, the supply path L11 has a throttle member S in the vicinity of the connection portion of the supply path L11 with the mixing device 13. The throttle member S is for narrowing at least a part of the flow path of the gaseous raw material (the flow path of the raw material) in the pipe constituting the supply path L11. Since the throttle member S is provided in the supply path L11 in the vicinity of the connection portion with the mixing device 13, a part of the flow path of the gaseous raw material is narrowed, and it is possible to prevent a fluid such as a liquid from flowing backward from the mixing device 13 toward the supply path L11. As described above, the throttle member S is an example of a suppression mechanism that suppresses the movement of the fluid in the mixing device 13 from the mixing device 13 toward the supply path L11.

The shape of the throttle member S is not particularly limited as long as it has a configuration that can prevent the backflow of the liquid into the mixing device 13. The throttle member S can be appropriately selected according to the properties of the raw material and the internal structure of the pipe constituting the supply path L11. Examples of the throttle member S include an orifice and a tee joint having different diameters.

In FIG. 2, S1 indicates the inner diameter of the pipe constituting the supply path L21, and S2 indicates the flow path diameter of the portion in which the flow path is locally narrowed by the throttle member S.

In the first embodiment, the throttle ratio (S2/S1) is preferably about 0.1 to 0.75. When the throttle ratio is equal to or larger than the lower limit, the supply pressure of the gaseous raw material is easily stabilized, and each raw material is easily supplied into the mixing device 13 continuously. When the throttle ratio is equal to or less than the upper limit, the backflow of the liquid caused by the pressure fluctuation in the reaction section 20 is easily suppressed, and the blockage of the pipe constituting the supply path L11 is easily prevented.

In FIG. 2, S3 indicates the length of the throttle member S in the gas supply direction. In the first embodiment, the length S3 of the throttle member S is preferably about 0.1 to 10 mm. When the length S3 of the throttle member S is equal to or greater than the lower limit, the physical strength of the throttle member S is easily maintained, and damage to the throttle member S is less likely to occur. When the length S3 of the throttle member S is equal to or less than the upper limit, blockage of the pipe constituting the supply path L11 is unlikely to occur, and the reaction efficiency is easily maintained for a long time.

In FIG. 2, S4 indicates the length of the supply path L11 located on the secondary side (downstream) with respect to the throttle member S. In the first embodiment, the length S4 of the supply route L11 located on the secondary side (downstream) with respect to the throttle member S is preferably 0 to 10 mm. When the length S4 is within the range, a decrease in the synthesis yield is unlikely to occur. The length S4 of the supply path L11A located on the secondary side with respect to the throttle member is more preferably 0 mm.

That is, “the supply path L11 has a throttle member S in the vicinity of the connection portion of the supply path L11 with the mixing device 13” means that the supply path L11 has the throttle member S at the connection portion of the supply path L11 with the mixing device 13 such that the length S4 of the supply path L11A located on the secondary side with respect to the throttle member S is 0 to 10 mm.

The parameters of S1, S2, S3, and S4 explained above can be appropriately selected according to the chemical reaction system to which the flow type reaction device 1 is applied. That is, each of the parameters can be appropriately selected according to a combination of two or more kinds of the raw materials or the like.

The mixing section 10 having the configuration above can supply a mixture containing the gaseous raw material and the liquid raw material into the reaction section 20 by continuously supplying the gaseous raw material and the liquid raw material into the mixing device 13 and mixing them. As described above, the mixing section 10 is an example of a device for mixing two or more kinds of the raw materials that are continuously supplied.

The supply paths L11 and L12 may be provided with a temperature control device such as a heater. Thereby, the temperature of the supply paths L11 and L12 can be adjusted to a temperature suitable for the chemical reaction of the raw materials.

The reaction section 20 is provided on the secondary side with respect to the mixing section 10. The reaction unit 20 includes a supply path 121 for the mixture of the raw materials mixed in the mixing section 10, a reaction field 21 provided in the supply path L21, and a back pressure valve 22 provided in the supply path L21 between the reaction field 21 and the separation section 30.

The supply path L21 is a path connecting the mixing section 10 and the separation section 30. The pipe constituting the supply path L21 has a first end connected to the mixing device 13 and a second end connected to the separation section 30. Thereby, the reaction section 20 can supply the fluid flowing in the supply path L21 to the separation section 30.

The material of the pipe constituting the supply path L21 is not particularly limited, and the same material as that of the supply paths L11 and L12 described above can be used.

The diameter of the pipe constituting the supply path L21 can be appropriately selected according to the supply amount of the mixture into the separation section 30. Specifically, for example, a pipe having an outer diameter of 1 to 30 mm can be used.

The reaction field 21 is a field in which two or more kinds of the raw materials (gaseous raw material and liquid raw material) chemically react. The configuration of the reaction field 21 is not particularly limited as long as the reaction time of the chemical reaction can be controlled. For example, in the present embodiment, the reaction field 21 is formed by a spiral pipe.

The length of the pipe constituting the reaction field 21 can be appropriately selected according to various factors such as a raw material, a target substance, and a reaction efficiency of a chemical reaction. For example, when the reaction time is set to a long time, the pipe length of the reaction field 21 may be increased. When the reaction time is set to a short time, or when a chemically unstable reaction intermediate is produced as a target substance, the pipe length of the reaction field 21 may be shortened. The material of the pipe constituting the reaction field 21 can be appropriately selected according to various factors such as temperature and pressure during the chemical reaction.

The inner diameter of the pipe constituting the reaction field 21 is preferably 2 mm or more. When the inner diameter is equal to or larger than the lower limit, clogging in the reaction field 21 is easily prevented, so that the supply amount of the raw materials can be sufficiently maintained, and high productivity can be easily realized.

The inner diameter of the pipe constituting the reaction field 21 is preferably 30 mm or less. When the inner diameter is equal to or less than the upper limit, the reaction efficiency of the chemical reaction in the reaction field 21 tends to increase.

The back pressure valve 22 is a valve that controls the pressure of the reaction field 21. As a result, the pressure in the reaction field 21 can be maintained at an optimal pressure for the chemical reaction of the raw materials, and the products generated in the reaction field 21 can be supplied into the separation section 30 at a stable flow rate. Further, by providing the back pressure valve 22 on the primary side (upstream side) of the separation section 30, the product can be continuously supplied into the gas-liquid separator 31 while maintaining the reduced pressure state of the gas-liquid separator 31 provided in the separation section 30.

According to the reaction section 20 having the configuration above, a product can be obtained by continuously chemically reacting the raw materials mixed in the mixing section 10. Further, the reaction section 20 can continuously supply a product (a mixture containing the diborane gas and the solvent in a gas-liquid coexisting state) by the chemical reaction into the separation section 30. Thus, the reaction section 20 is an example of an embodiment of a device for controlling a continuous chemical reaction of raw materials.

The separation section 30 is provided on the secondary side with respect to the reaction section 20. The separation section 30 includes a gas-liquid separator 31 connected to the supply path L21, a gas recovery path L31 for discharging gas in the gas-liquid separator 31 to the outside of the gas-liquid separator 31, a liquid recovery path L32 for discharging the liquid in the gas-liquid separator 31 to the outside of the gas-liquid separator 31, and a control device 32.

The gas-liquid separator 31 is a container that separates a mixture containing a gas and a liquid in a gas-liquid coexisting state into the gas and the liquid, and stores them in an airtight space provided inside.

The space inside the gas-liquid separator 31 communicates with the supply path L21. Thereby, the mixture is supplied into the gas-liquid separator 31 via the supply path L21. The airtight space in the gas-liquid separator 31 is divided into a gas phase 31A and a liquid phase 31B.

The gas-liquid separator 31 may be, for example, a container made of metal, such as SUS. Further, it is preferable that the gas-liquid separator 31 can withstand a reduced pressure state (for example, 20 to 40 kPa abs.).

The volume, inner diameter, and height of the gas-liquid separator 31 can be appropriately selected according to factors such as a yield of the target substance and the size of the flow type reaction device 1.

In the present embodiment, the inner diameter of the gas-liquid separator 31 is preferably 50 to 200 mm. When the inner diameter is equal to or larger than the lower limit, gas-liquid separation proceeds sufficiently, and the yield of the target substance is likely to be improved. When the inner diameter is equal to or less than the upper limit, the flow type reaction device 1 is easily reduced in size.

In the present embodiment, the height of the gas-liquid separator 31 is preferably 200 to 800 mm. When the height is greater than or equal to the lower limit, gas-liquid separation proceeds sufficiently, and the yield of the target substance is likely to be improved. When the height is equal to or less than the upper limit, the flow type reaction device 1 is easily reduced in size.

The configuration of the gas-liquid separator 31 is not particularly limited to a container as long as a mixture containing a gas and a liquid in a gas-liquid coexisting state can be separated into the gas and the liquid and stored in an airtight space provided inside. For example, a configuration may be adopted in which an airtight space is provided by making at least a part of a pipe connecting the supply path L21 and the liquid recovery path L32 larger in diameter than the supply path L21. According to such a configuration, a mixture containing the gas and the liquid in a gas-liquid coexisting state can be separated into the gas and the liquid, and can be stored in the airtight spaces provided inside.

The gas-liquid separator 31 is provided with a liquid level gauge 33. The liquid level gauge 33 can detect the height of the interface (that is, the liquid level) between the gas phase 31A and the liquid phase 31B in the space inside the gas-liquid separator 31. The liquid level gauge 33 is not particularly limited as long as the liquid level in the gas-liquid separator 31 can be detected. Examples of the liquid level gauge 33 include a float type, a reflection type, a tube type, and a perspective type liquid level gauges.

The gas recovery path L31 is a pipe that communicates with the gas phase 31A of the gas-liquid separator 31. In the gas recovery path L31, an opening adjustment valve 34 and a pressure reducing device 35 are provided in this order from the primary side (upstream side).

The opening adjustment valve 34 is a valve that adjusts the opening of the pipe that forms the gas recovery path L31. Thereby, the flow rate of the gas flowing through the gas recovery path L31 can be adjusted. The opening adjustment valve 34 is not particularly limited, and examples thereof include an automatic needle valve and a butterfly valve.

The pressure reducing device 35 is a device for reducing the pressure in the gas recovery path L31. The pressure reducing device 35 is not particularly limited, and a pressure reducing pump, and the like are exemplary examples. The pressure reducing device 35 is provided in the gas recovery path L31 in order to suck and recover the target substance (diborane gas) from the gas phase 31A in the gas-liquid separator 31.

The ability of the pressure reducing device 35 is not particularly limited as long as the gas phase 31A of the gas-liquid separator 31 can be reduced to a required pressure (for example, about 50 to 500 hPa abs.). The pressure reducing device 35 can be appropriately selected according to the components of the mixture supplied into the gas-liquid separator 31. As the pressure reducing device 35, a vacuum/pressure reducing pump (for example, “BA-106F” manufactured by Iwaki Co., Ltd.) and the like are exemplary examples.

According to the flow type reaction device 1, by operating the pressure reducing device 35, the pressure of the gas phase 31A of the gas-liquid separator 31 can be reduced, for example, to 50 to 500 hPa abs. Then, the target substance (diborane gas) can be recovered from the secondary side with respect to the pressure reducing device 35.

As described above, the gas recovery path L31 can discharge the target substance or the like continuously supplied into the gas phase 31A of the gas-liquid separator 31 from the gas-liquid separator 31 while adjusting the flow rate.

The material of the pipe constituting the gas recovery path L31 is not particularly limited, and the same material as that of the supply paths L11, L12, and L21 can be used. The diameter of the pipe constituting the gas recovery path L31 is not particularly limited, and a pipe having the same diameter as that of the supply paths L11, L12, and L21 can be used.

In addition, on the secondary side with respect to the pressure reducing device 35 of the gas recovery path L31, a flow meter for measuring the yield of the recovered target substance (diborane gas), a container for storing the target substance, a purifier for purifying the target substance, or an instrument such as an analyzer (eg, FT-IR) for analyzing the concentration of the target substance may be provided as needed. Further, the gas recovery path L31 may be connected to a reactor or the like on the rear stage on the secondary side with respect to the pressure reducing device 35.

The liquid recovery path L32 is a pipe that communicates with the liquid phase 31B of the gas-liquid separator 31. An on-off valve (on-off device) 36 is provided in the liquid recovery path L32.

The on-off valve 36 is not particularly limited as long as it switches the opening and closing of the pipe constituting the liquid recovery path L32. As the on-off valve 36, a manual diaphragm valve, a ball valve, and the like are exemplary examples.

By opening the on-off valve 36, the discharge of the liquid from the gas-liquid separator 31 to the liquid recovery path L32 can be started. On the other hand, by closing the on-off valve 36, the discharge of the liquid from the gas-liquid separator 31 to the liquid recovery path L32 can be stopped. Thereby, the liquid recovery path L32 can discharge the liquid continuously supplied into the gas-liquid separator 31.

The material of the pipe constituting the liquid recovery path L32 is not particularly limited, and the same material as that of the supply path L11, L12, L21 or the gas recovery path L31 can be used. The diameter of the pipe constituting the liquid recovery path 132 is not particularly limited, and a pipe having the same diameter as that of the supply path L11, L12, L21 or the gas recovery path L31 can be used.

In addition, on the secondary side with respect to the on-off valve 36 of the liquid recovery path L32, a purification device such as an evaporator that can condense the solvent may be provided. Thereby, the ether-based solvent discharged from the inside of the gas-liquid separator 31 is introduced into the purification device. The condensed and purified ether-based solvent can be reused as the liquid raw material. The solid contained in the solvent is separated from the solvent and discarded as a solid.

Further, in the purification device, diborane gas dissolved in the ether-based solvent is separated and recovered from the liquid. Thereby, the target substance (diborane gas) can be recovered with higher efficiency.

The control device 32 includes a controller that drives each drive unit and a control unit that controls each controller as an operation control system. Each controller is formed of, for example, a PID controller, and is electrically connected to an actuator or the like provided in the liquid level gauge 33, the opening adjustment valve 34, the on-off valve 36, and the like. Each controller starts, stops, adjusts, and the like of each unit. Thereby, each controller can control the conditions such as the pressure in the gas-liquid separator 31 and the liquid level at a constant level.

According to the separation section 30 having the above configuration, the target substance, diborane gas, can be separated from the product (a mixture containing the diborane gas and the solvent in a gas-liquid coexisting state) generated in the reaction section 20. As described above, the separation section 30 is an example of a device that separates a gas and a liquid from a mixture containing at least the gas and the liquid in a gas-liquid coexisting state, and collects them.

Hereinafter, an example of an operation method of the flow type reaction device 1 will be described.

First, in the mixing section 10, the ether-based solvent is continuously supplied from the supply source 12 of liquid raw material into the mixing device 13 via the supply path L12 by the liquid feed pump 18 while adjusting the flow rate by the mass flow controller 19.

Next, while controlling the pressure by the pressure regulating valve 16 and the flow rate by the mass flow controller 17, respectively, the boron trihalide gas such as BF₃ and BCl₃ is supplied from the supply source 11 of the gaseous raw material into the mixing device 13 via the supply path L11.

The supply conditions of the liquid raw material are not particularly limited, and can be appropriately selected according to various factors. For example, when supplying the liquid raw material, conditions of a pressure of 0.1 to 1.5 MPaG, a flow rate of 50 to 2,000 mL/min, and a concentration of 0.25 to 2 mol/L can be applied.

Similarly, the supply conditions of the gaseous raw material are not particularly limited, and can be appropriately selected according to various factors. For example, when supplying the gaseous raw material, conditions of a pressure of 0.1 to 1.5 MPaG, a flow rate of 1.5 to 3 L/min, and a concentration of 100 mol % can be applied.

In the mixing device 13, the gaseous raw material and the liquid raw material are mixed. The manner of mixing the gaseous raw material and the liquid raw material is not particularly limited. For example, the gaseous raw material and the liquid raw material may be alternately and continuously supplied, and mixed by forming a plug flow in which the gaseous material and the liquid material are alternately divided into small segments. Thereby, the gaseous raw material and the liquid raw material can be immediately mixed and high mixing uniformity can be realized.

In the reaction section 20, the gaseous raw material and liquid raw material which have been mixed continuously react. As a result, a product containing diborane gas, which is the target substance, and an ether-based solvent in a gas-liquid coexisting state is continuously produced. The products may include by-products of the reaction.

The product is continuously supplied at a stable flow rate into the gas-liquid separator 31 via the back pressure valve 22 provided in the supply path L21. During this time, the reduced pressure state is maintained in the gas-liquid separator 31 by the back pressure valve 22.

The reaction conditions of the reaction section 20 are not particularly limited, and can be appropriately selected according to various factors. For example, when producing the product above, conditions of a residence time in the reaction field 21 of 1 second to 10 minutes and a pressure of the reaction field 21 of 0.01 to 1 MPaG can be applied.

The product supplied into the gas-liquid separator 31 is separated into the diborane gas and the ether-based solvent, and forms the gas phase 31A and the liquid phase 31B in the gas-liquid separator 31, respectively. The inside of the gas-liquid separator 31 is depressurized by the pressure reducing device 35 provided in the gas recovery path L31 communicating with the gas phase 31A.

The reduced pressure state in the gas-liquid separator 31 is controlled by the control device 32 so as to be kept constant. Conditions such as the pressure and the height of the liquid surface in the gas-liquid separator 31 are not particularly limited, and can be appropriately selected according to various factors. For example, the conditions in which the pressure in the gas-liquid separator 31 is in a range from 20 to 40 kPa abs, and the height of the liquid surface in the gas-liquid separator 31 is in a range from 70 to 100 mm from the bottom of the gas-liquid separator 31 can be applied.

The diborane gas in the gas-liquid separator 31 is recovered from the secondary side with respect to the pressure reducing device 35.

The recovered diborane gas may be recovered after being purified by a purifier provided at a subsequent stage, or may be supplied into a reaction device provided at a subsequent stage.

When the product is continuously supplied into the gas-liquid separator 31 and the diborane gas is recovered, the liquid phase 31B in the gas-liquid separator 31 increases, and the liquid level rises. When the position of the liquid level reaches a predetermined set value input to the liquid level gauge 33, the signal value is transmitted to the control device 32.

Next, an open signal is transmitted from the control device 32 to the on-off valve 36. Upon receiving the signal, the on-off valve 36 is opened, and the ether-based solvent in the gas-liquid separator 31 is discharged to the liquid recovery path L32. Thereby, the ether-based solvent containing the by-product is recovered. The discharged ether-based solvent and the by-products may be recovered after being purified by a purifier provided at a subsequent stage, or may be supplied into the supply source 12 of the liquid raw material for reuse.

When the ether-based solvent is recovered, the liquid phase 31B in the gas-liquid separator 31 decreases, and the liquid level drops. When the position of the liquid surface reaches a predetermined set value input to the liquid level gauge 33, the signal value is transmitted to the control device 32, and a close signal is transmitted from the control device 32 to the on-off valve 36. Upon receiving the signal, the on-off valve 36 is closed, and the discharge of the ether-based solvent in the gas-liquid separator 31 to the liquid recovery path L32 is stopped.

As described above, the flow type reaction device 1 can continuously supply the gaseous raw material and the liquid raw material and continuously react these raw materials to continuously produce diborane gas as a target substance. In this embodiment, the flow type reaction device 1 has been described by taking diborane gas production as an example. However, the present embodiment can be applied to the production of other chemical substances.

For example, the flow type reaction device 1 may be configured to produce hydrogen by using gaseous raw materials, an acid such as acetic acid or hydrochloric acid and a metal hydride such as NaH or NaBH₄. Further, a configuration in which carbon dioxide is produced using calcium carbonate and hydrochloric acid as the raw materials may be adopted. Further, a configuration may be employed in which perchloric acid and hydrochloric acid are used as the raw materials to produce chlorine gas. In addition, the compounds disclosed here is an example, and application of the flow type reaction device 1 is not limited to these examples.

According to the flow type reaction device 1 of the first embodiment described above, even if the pressure of the reaction field 21 suddenly fluctuates due to the chemical reaction and the liquid likely to flow backward in the mixing device 13, the liquid can be pushed back by the throttle member S. Therefore, the flow type reaction device 1 makes it difficult for the liquid to flow backward in the mixing device, and can prevent the supply path from being blocked due to the reverse flow. Therefore, since the flow type reaction device 1 can continuously supply the gaseous raw material to the mixing device, the reaction efficiency hardly decreases even when the flow type reaction device is operated for a long period of time, and high productivity can be maintained.

Moreover, the flow type reaction device 1 can prevent the blockage of the pipe by providing the throttle member S inside the supply path L11. Since the throttle member S does not require a complicated configuration, for example, a device such as an ultrasonic vibrator, the size and cost of the device can be reduced.

The flow type reaction device 1 according to the first embodiment can be suitably used to a chemical reaction system in which even if the supplied raw materials stay in the mixing device 13, it does not easily affect the reaction efficiency of the chemical reaction.

(First Modification of First Embodiment)

Hereinafter, the flow type reaction device according to the first modification of the first embodiment will be described.

The flow type reaction device according to the first modification of the first embodiment has the same configuration as that of the flow type reaction device 1 described above except that the throttle member S is provided in the supply path L12A in the vicinity of the connection portion of the supply path L12 with the mixing device 13, and the throttle member S is not provided in the supply path L11A in the vicinity of the connection portion of the supply path L11 with the mixing device 13.

With the flow type reaction device according to the first modification of the first embodiment, the same operation and effect as those of the flow type reaction device 1 can be obtained.

(Second Modification of First Embodiment)

Hereinafter, the flow type reaction device according to the second modification of the first embodiment will be described.

The flow type reaction device according to the second modification of the first embodiment has the same configuration as that of the flow type reaction device 1 described above except that the throttle member S is provided in both the supply path L11A in the vicinity of the connection portion of the supply path L11 with the mixing device 13 and the supply path L12A in the vicinity of the connection portion of the supply path L12 with the mixing device 13.

With the flow type reaction device according to the second modification of the first embodiment, the same operation and effect as those of the flow type reaction device 1 can be obtained.

### Second Embodiment

Hereinafter, the flow type reaction device according to the second embodiment will be described.

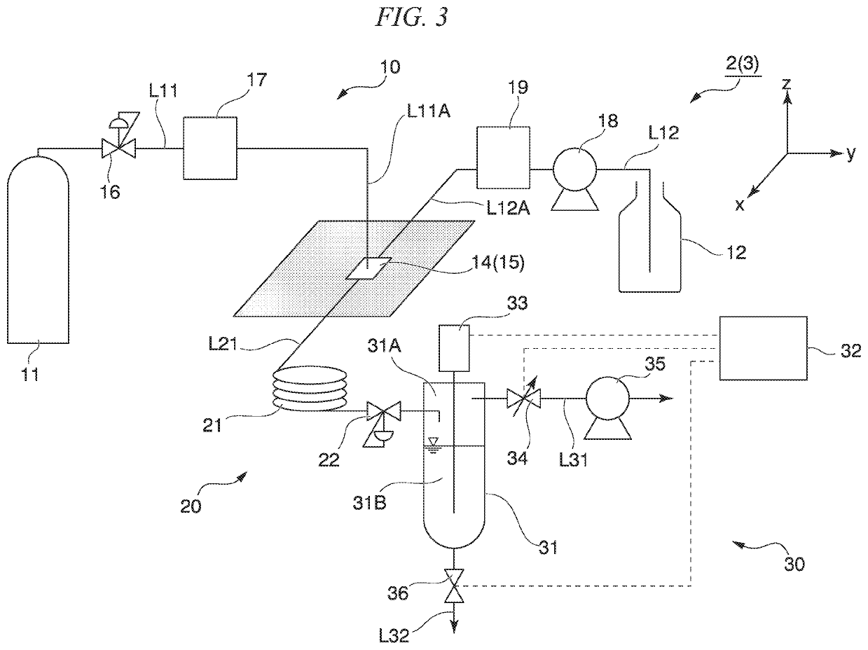

FIG. 3 is a system diagram schematically showing an example of a configuration of the flow type reaction device 2. In FIG. 3, the z-axis direction is the vertical direction as in FIG. 1. As shown in FIG. 3, the flow type reaction device 2 according to the second embodiment includes a mixing device 14 instead of the mixing device 13. Further, in the second embodiment, the primary portion L11A of the supply path L11 with respect to the mixing device 14, which is the connection portion of the supply path L11 with the mixing device 14, is connected to the mixing device 14 from above with respect to the x-y plane shown in FIG. 3.

The flow type reaction device 2 according to the second embodiment differs from the flow type reaction device 1 in the configuration described above, and has the same configuration as that of the flow type reaction device 1 described above except for the configuration above. Hereinafter, description of the same components as those of the flow type reaction device 1 will be omitted.

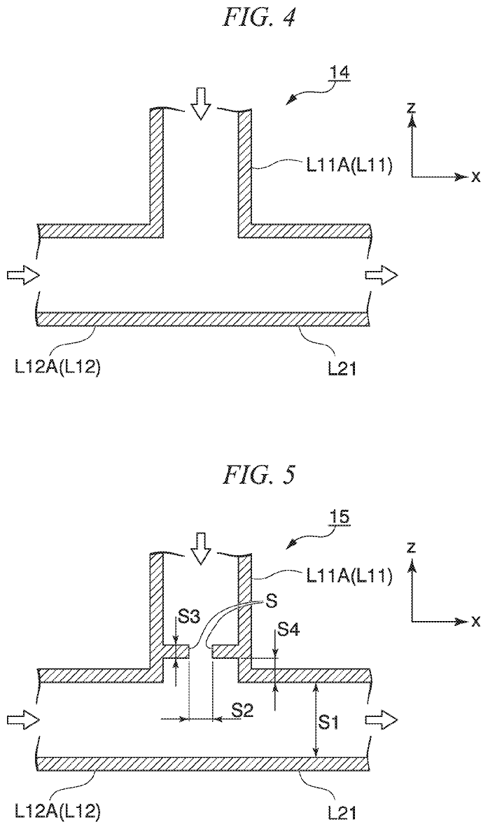

FIG. 4 is a cross-sectional view in the x-z plane direction showing the mixing device 14 included in the flow type reaction device 2. As shown in FIG. 4, in the second embodiment, the primary portion L11A of the supply path L11 with respect to the mixing device 14, which is the connection portion of the supply path L11 with the mixing device 14, is connected to the mixing device 14 in the z-axis direction from above with respect to the x-y plane. That is, the primary portion L11A of the supply path L11 is connected to the mixing device 14 from above vertically.

In the second embodiment, no throttle member is provided in the vicinity of the connection portion of the supply path L11 with the mixing device 14 and in the vicinity of the connection portion of the supply path L12 with the mixing device.

In the second embodiment, the gaseous raw material is introduced from above the mixing device 14 (in the z-axis direction) via the supply path L11. Thereby, even if the liquid is likely to flow backward toward the supply path L11, the liquid can be pushed back from above by the supply of the gaseous raw material. Further, even if the liquid in the mixing device 14 is likely to flow backward toward the supply path L11, the liquid does not easily flow backward due to the action of gravity in addition to the supply of the gaseous raw material.

According to the flow type reaction device 2 of the second embodiment described above, it is difficult for the liquid in the mixing device 14 to flow backward. Even if the liquid flows backward, the liquid is easily affected by gravity, is easily drawn out from the pipe forming the supply path L11, and is unlikely to stay in the pipe for a long time. As a result, clogging due to drying of the liquid and precipitation of the solid hardly occurs. Therefore, the flow type reaction device 2 has the same operation and effect as those of the flow type reaction device 1 according to the first embodiment.

The flow type reaction device 2 according to the second embodiment can be suitably used to a chemical reaction system in which a difference in compressibility between two or more kinds of the raw materials is small in a chemical reaction, a chemical reaction system in which pressure fluctuation due to the chemical reaction is small, and the like.

(Modification of Second Embodiment)

Hereinafter, a flow type reaction device according to a modification of the second embodiment will be described. The flow type reaction device of the modification of the second embodiment has the same configuration as that of the flow type reaction device according to the second embodiment except that the primary portion L11A of the supply path L11 with respect to the mixing device 14, which is the connection portion of the supply path L11 with the mixing device 14, forms an angle of ω° with respect to the z axis and is connected to the mixing device 14 from above with respect to the x-y plane.

The ω is preferably set in the range of 0 to 45°. When the w is less than or equal to the upper limit, even if the liquid in the mixing device 14 flows backward, the liquid is likely to be promptly led out from the pipe constituting the supply path L11.

With the flow type reaction device according to the modification of the second embodiment, the same operation and effect as those of the flow type reaction device 2 can be obtained.

### Third Embodiment

Hereinafter, the configuration of the flow type reaction device 3 according to the third embodiment of the present invention will be described.

FIG. 3 is a system diagram schematically showing an example of the configuration of the flow type reaction device 3. As shown in FIG. 3, the flow type reaction device 3 according to the third embodiment includes a mixing device 15 instead of the mixing device 13 or 14. Further, in the third embodiment, the primary portion L11A of the supply path L11 with respect to the mixing device 15, which is the connection portion of the supply path L11 with the mixing device 15, is connected to the mixing device 15 from above with respect to the x-y plane shown in FIG. 3. The flow type reaction device 3 according to the third embodiment is different from the flow type reaction device 1 in the configuration described above, and has the same configuration as that of the above-described flow type reaction device 1 except for the configuration. Hereinafter, description of the same components as those of the flow type reaction device 1 will be omitted.

FIG. 5 is a cross-sectional view in the x-z plane direction showing the mixing device 15 included in the flow type reaction device 3. As shown in FIG. 5, in the third embodiment, a throttle member S is provided in the supply path L11A in the vicinity of the connection portion of the supply path L11 with the mixing device 15.

In FIG. 5, S4 indicates the length of the supply path L11A (L11) located on the secondary side (downstream side) with respect to the throttle member S. In the third embodiment, the length S4 of the supply path L11A located on the secondary side with respect to the throttle member S is preferably 0 to 10 mm. When the length S4 is within the above range, a decrease in the synthesis yield is unlikely to occur. The length S4 of the supply path L11A located on the secondary side with respect to the throttle member S is more preferably 0 mm.

That is, “the supply path L11A has a throttle member S in the vicinity of the connection portion of the supply path L11 with the mixing device 15” means that the supply path L11A has the throttle member S at the connecting portion of the supply path L11A with the mixing device 15 such that the length S4 of the supply path L11A (L11) located on the secondary side with respect to the throttle member S is 0 to 10 mm.

Since the throttle member S is provided in the supply path L11A in the vicinity of the connection portion with the mixing device 15, the liquid can be prevented from flowing backward from the mixing device 15 toward the supply path L11. The detailed configuration such as the shape and type of the throttle member S, the throttle ratio (S2/S1), the length S3 of the throttle member S, and the length S4 of the supply path 11A located on the secondary side with respect to the throttle member S are the same as those described in the first embodiment.

As shown in FIG. 5, in the third embodiment, the primary portion L11A of the supply path L11 with respect to the mixing device 15, which is the connection portion of the supply path L11 with the mixing device 15, is connected to the mixing portion 15 in the z-axis direction from above with respect to the x-y plane, that is, from above vertically. Thereby, even if the liquid flows backward toward the supply path L11, the liquid that has flowed backward can be pushed back from above by the supply of the gaseous raw material. Further, even if the liquid in the mixing device 15 is likely to flows backward toward the supply path L11, the liquid that has flowed backward is immediately drawn out of the supply path L11 under the action of gravity.

According to the flow type reaction device 3 of the third embodiment described above, productivity and reaction efficiency which are sufficient for practical use can be maintained for a longer time in addition to the same operation and effects as those of the flow type reaction device 1 according to the first embodiment can be obtained.

Further, the flow type reaction device 3 has a stronger effect of preventing the backflow and the effect of suppressing stagnation in the mixing device than the flow type reaction devices 1 and 2. Therefore, even the target substance (diborane gas) having a high pressure of about 1 MPaG can be continuously produced. Furthermore, since blockage due to drying of the liquid and precipitation of the solid is less likely to occur, the operation and stop of the flow type reaction device can be repeated as many times as desired.

(First Modification of Third Embodiment)

Hereinafter, a flow type reaction device according to a first modification of the third embodiment will be described. The flow type reaction device of the first modification of the third embodiment has the same configuration as that of the flow type reaction device 3 according to the third embodiment except that the throttle member S is provided in the supply path L12A in the vicinity of the connection portion of the supply path L12 with the mixing device 15, and is not provided in the supply path L11A in the vicinity of the connection portion of the supply path L11 with the mixing device 15.

With the flow type reaction device according to the first modification of the third embodiment, the same operation and effect as those of the flow type reaction device 3 can be obtained.

(Second Modification of Third Embodiment)

Hereinafter, a flow type reaction device according to a second modification of the third embodiment will be described. The flow type reaction device of the second modification of the third embodiment has the same configuration as that of the flow type reaction device 3 according to the third embodiment except that the throttle member S is provided in both the supply path L11A in the vicinity of the connection portion of the supply path L11 with the mixing device 15 and the supply path L12A in the vicinity of the connection portion of the supply path L12 with the mixing device 15.

With the flow type reaction device according to the second modification of the third embodiment, the same operation and effect as those of the flow type reaction device 3 can be obtained.

### Another Embodiment

Hereinafter, a configuration of a flow type reaction device according to another embodiment of the present invention will be described.

A flow type reaction device of the present embodiment has the same configuration as that of the flow type reaction device 1 described above, except that the separation section 30 includes a second pressure reducing device in addition to the pressure reducing device 35.

The second pressure reducing device is provided in the liquid recovery path L32. Thereby, the second pressure reducing device can reduce the pressure inside the liquid recovery path L32. The second pressure reducing device is electrically connected to the control device 32.

The ability of the second pressure reducing device is not particularly limited as long as the pressure inside the liquid recovery path 132 can be reduced to a pressure equal to or higher than the pressure in the gas-liquid separator 31 (the pressure of the gas phase 31A), and can be appropriately selected according to the ability of the pressure reducing device 35. Further, the second pressure reducing device may be the same as the pressure reducing device 35 or may be different.

In the flow type reaction apparatus of the present embodiment, when the position of the liquid surface of the liquid phase 31B of the gas-liquid separator 31 reaches a predetermined set value input to the liquid level gauge 33, the signal value is transmitted to the control device 32. Then, an operation signal is sent from the control device 32 to the second pressure reducing device. Thereby, the second pressure reducing device starts operating such that the pressure in the liquid recovery path L32 is lower than the pressure in the gas-liquid separator 31.

According to the flow type reaction device of the present embodiment described above, the pressure of the liquid recovery path L32 can be reduced more than that of the gas-liquid separator 31. Therefore, according to the present embodiment, the liquid can be easily recovered from the liquid phase 31B inside of the gas-liquid separator 31 via the liquid recovery path L32, and air is can be hardly mixed into the gas-liquid separator 31 in a reduced pressure state.

While some embodiments of the present invention have been described above, the present invention is not limited to such specific embodiments. In the present invention, additions, omissions, substitutions, and other modifications of the configuration may be made within the scope of the invention described in the claims.

For example, in the embodiments described above, the primary portion 112A of the supply path L12 of the liquid source with respect to the mixing device, which is the connection portion of the supply path L12 of the liquid source with the mixing device, is arranged on the x-y plane, and the supply path L12 of the liquid source is connected to the mixing device. However, the primary portion L12 may be connected to the mixing device from above with respect to the x-y plane.

In addition, without using a mixing device such as a mixer, the secondary side end of the supply path L11 and the secondary side end of the supply path L12 are connected, and the junction portion between the supply path L11 and the supply path L12 may be used as a mixing device, and two or more types of raw materials may be mixed at the junction portion.

### EXAMPLES

Hereinafter, the present invention will be described specifically with reference to examples, but the present invention is not limited by the following description.

### Example 1

Diborane gas was continuously synthesized using the flow type reaction device 1 according to the first embodiment. As specific reaction conditions, BF₃ was used as a gaseous raw material, and an ether-based solvent in which a reducing agent was dissolved in ether was used as a liquid raw material. Furthermore, the throttle ratio (S2/S1) of the throttle member S was 0.25, the length S3 of the throttle member S was 1 mm, and the length S4 of the supply path 11A located on the secondary side with respect to the throttle member S was 0 mm.

The liquid raw material used was distilled and purified by an evaporator (not shown in figure) provided on the secondary side (downstream side) of the liquid recovery path L32, introduced again to the liquid material supply source 12, circulated and reused. The flow rate of the diborane gas recovered from the gas recovery path L31 was measured by a float type flow meter (not shown in figure) provided on the secondary side with respect to the pressure reducing device 35. Further, the purity of the diborane gas produced was measured by FT-IR (not shown in figure) provided on the secondary side with respect to the pressure reducing device 35.

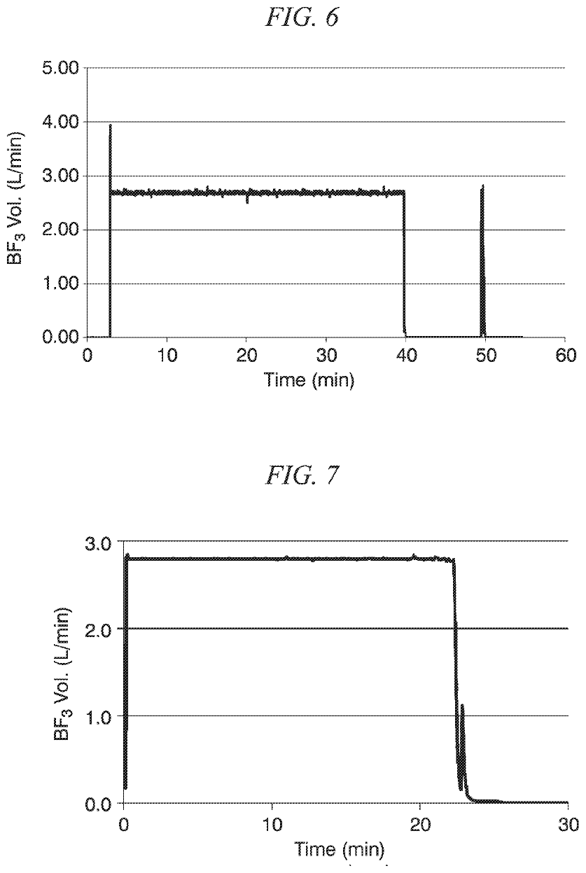

FIG. 6 is a diagram showing a change over time in the supply amount of the gaseous raw material in Example 1. As shown in FIG. 6, in Example 1, BF₃ gas could be continuously supplied and the diborane gas could be continuously synthesized for 35 minutes or more. As a result of measurement with the flow meter, the yield of the diborane gas was about 85 to 90%. As a result of analyzing the obtained diborane gas by the FT-IR, the purity of the diborane gas was 99 mol %.

In Example 1, the supply of the BF₃ gas was stopped 40 minutes after the start of the supply of the BF₃ gas, the synthesis reaction was stopped, and then the synthesis reaction was started again. As a result, as shown by the peak of about 50 minutes on the horizontal axis in FIG. 6, during the stop of the synthesis reaction of the flow type reaction device of Example 1, the pipe of the supply path was blocked, and the BF₃ gas could not be supplied even when trying to restart the synthesis reaction.

### Example 2

Diborane gas was synthesized under the same conditions as those in Example 1 except that the flow type reaction device 2 according to the second embodiment was used.

FIG. 7 is a diagram showing a change over time in the supply amount of the gaseous raw material in Example 2. As shown in FIG. 7, in Example 2. BF₃ gas could be continuously supplied, and the diborane gas could be continuously synthesized for about 20 minutes. However, thereafter, the supply amount of the BF₃ gas rapidly decreased, suggesting that the supply path was blocked. As a result of measurement with the flow meter, the yield of the diborane gas was about 85 to 90%. As a result of analyzing the obtained diborane gas by the FT-IR, the purity of the diborane gas was 99 mol %.

### Example 3

Diborane gas was synthesized under the same conditions as in Example 1 except that the flow type reaction device 3 according to the third embodiment was used.

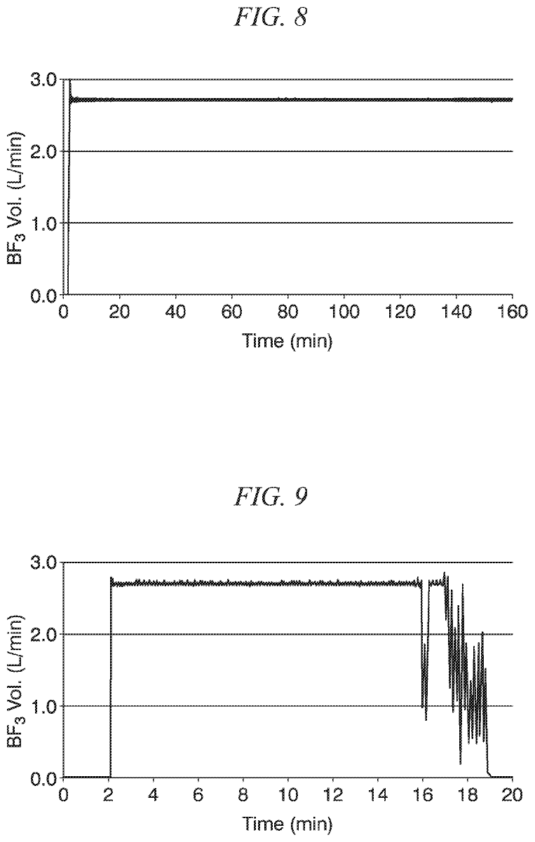

FIG. 8 is a diagram showing a change over time of the supply amount of the gaseous raw material in Example 3. As shown in FIG. 8, in Example 3, BF₃ gas could be continuously supplied, and diborane gas could be continuously synthesized for 160 minutes or more. As a result of measurement with the flow meter, the yield of diborane gas was about 85 to 90%. As a result of analyzing the obtained diborane gas by the FT-IR, the purity of the diborane gas was 99%. As a result of analyzing the solvent recovered by the evaporator by FT-IR, no residual BF₃ gas as the gaseous raw material was confirmed.

In Example 3, as in Example 1, the synthesis reaction was stopped, and then the synthesis reaction was started again. As a result, while the synthesis reaction was stopped, there was no sign indicating that the pipe of the supply path was blocked, and BF₃ gas could be supplied smoothly as before the synthesis reaction was stopped.

### Comparative Example 1

Diborane gas was synthesized under the same conditions as in Example 1 except that, in the flow type reaction device shown in FIG. 1, the mixing device 13 is replaced with a mixing device having no throttle member S, and the primary portion L11A of the supply path L11 with respect to the mixing device 13, which is the connection portion of the supply path L11 with the mixing device 13 is horizontally disposed on the x-y plane, not vertically above the mixing device.

FIG. 9 is a diagram showing a change over time in the supply amount of the gaseous raw material in Comparative Example 1. As shown in FIG. 9, in Comparative Example 1, the supply amount of the gaseous raw material became unstable after 15 minutes from the start of operation, and the gaseous raw material could not be supplied at all after 20 minutes. When the inside of the supply path L11 was visually confirmed, deposition of the solvent and the solid was confirmed, and it was suggested that the pipe was blocked by the backflow. No significant difference was observed in the purity and yield of the diborane gas from the examples in the period of 15 minutes or less from the start of operation, but after 15 minutes, the yield of the diborane gas was significantly reduced, and the purity of diborane gas was also reduced.

From the results of the above Examples and Comparative Example 1, it was shown that the flow type reaction devices of Examples 1 to 3 can operate the device continuously for a long time. In addition, it was shown that the flow type reaction device of Example 3 can repeatedly stop and restart the synthesis reaction.

The yield of the diborane gas obtained in each Example was at a level sufficient for practical use. Further, the purity of the diborane gas was high, and high-quality diborane gas was obtained.

### EXPLANATION OF REFERENCE NUMERAL

1, 2, 3 flow type reaction device
10 mixing section
11 supply source of gaseous raw material
12 supply source of liquid raw material
13, 14, 15 mixing device
16 pressure regulating valve
17 mass flow controller
18 liquid feed pump
19 mass flow controller
20 reaction section
21 reaction field
22 back pressure valve
30 separation section
31 gas-liquid separator
31A gas phase
31B liquid phase
32 control device
33 liquid level gauge
34 opening adjustment valve
35 pressure reducing device
36 on-off valve
L11, L12, L21 supply path
L31 gas recovery path
L32 liquid recovery path
S throttle member
S1 inner diameter
S2 flow path diameter
S3 length of throttle member
S4 length of supply path located on secondary side of throttle member

1. A flow type reaction device for continuously reacting two or more kinds of raw materials,
wherein the flow type reaction device includes a mixing section which is configured to mix two or more kinds of the raw materials, and a reaction section which is provided on a secondary side with respect to the mixing section, and configured to obtain a product by reacting two or more kinds of the raw materials,
the mixing section includes a mixing device which is configured to mix two or more kinds of the raw materials, and two or more supply pipes which are configured to supply each of two or more kinds of the raw materials to the mixing device,
the supply pipes are respectively connected to the mixing device, and at least one of the supply pipes has, in the vicinity of a connection portion of the supply pipe with the mixing device, a suppression mechanism which is configured to suppress movement of a fluid from the mixing device to the supply pipe.

2. A flow type reaction device for continuously reacting two or more kinds of raw materials,
wherein the flow type reaction device includes a mixing section which is configured to mix two or more kinds of the raw materials, and a reaction section which is provided on a secondary side with respect to the mixing section, and configured to obtain a product by reacting two or more kinds of the raw materials,
the mixing section includes a mixing device which is configured to mix two or more kinds of the raw materials, and two or more supply pipes which are configured to supply each of two or more kinds of the raw materials to the mixing device,
the supply pipes are respectively connected to the mixing device, and at least one of the supply pipes is connected to the mixing device from above with respect to a plane on which the mixing device is disposed.

3. A flow type reaction device for continuously reacting two or more kinds of raw materials,
wherein the flow type reaction device includes a mixing section which is configured to mix two or more kinds of the raw materials, and a reaction section which is provided on a secondary side with respect to the mixing section, and configured to obtain a product by reacting two or more kinds of the raw materials,
the mixing section includes a mixing device which is configured to mix two or more kinds of the raw materials, and two or more supply pipes which are configured to supply each of two or more kinds of the raw materials to the mixing device,
the supply pipes are respectively connected to the mixing device, and at least one of the supply pipes has, in the vicinity of a connection portion of the supply pipe with the mixing device, a suppression mechanism which is configured to suppress movement of a fluid from the mixing device to the supply pipe, and
at least one of the supply pipes is connected to the mixing device from above with respect to a plane on which the mixing device is disposed.

4. The flow type reaction device according to claim 1,
wherein two or more kinds of the raw materials are a combination of one or more kinds of gaseous raw materials and one or more kinds of liquid raw materials.

5. The flow type reaction device according to claim 2,
wherein two or more kinds of the raw materials are a combination of one or more kinds of gaseous raw materials and one or more kinds of liquid raw materials,
at least one of the supply pipes which is configured to supply the gaseous material to the mixing device is connected to the mixing device from above with respect to a plane on which the mixing device is disposed, and
at least one of the supply pipes which is configured to supplying the liquid raw material to the mixing device is connected to the mixing device in parallel to a plane on which the mixing device is disposed.

6. The flow type reaction device according to claim 1,
wherein the flow type reaction device further includes a separation section which is provided on a secondary side with respect to the reaction section, and configured to separate a target substance from a product.
